(19) United States
(12) Patent Application Publication
(10) Pub. No.: US 2004/0006525 A1
(43) Pub. Date: Jan. 8, 2004

(54) Providing stock shares having associated rights to use a property

(76) Inventors: Jack Roberts, Salt Lake City, UT (US); Edwin V. Davis II, Ogden, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/190,442

(22) Filed: Jul. 5, 2002

(51) Int. Cl. G06F 17/60

(52) U.S. Cl. 705/36

(57) ABSTRACT

Systems and methods for selectively providing stock shares that entitle rights to use a property. A management entity oversees and selectively schedules use of the property according to individual stock shares. In one implementation, the use is the dividend provided to the stockholder. In another implementation the use schedule is created by receiving use requests from stockholders and scheduling use of the property according to which stockholder first requested the property for the scheduled use period. In another implementation, a lottery system is used to assign use dates or periods to the individual shareholders. In yet another implementation, preference to use dates/periods is made based on the number of stock shares or the type of stock shares (e.g., shares of a preferred stock) owned by the stockholder. Stock shares are exchanged at a public or electronic exchange.

### BACKGROUND OF THE INVENTION

1. Field of the Invention

The present invention relates to providing rights to use a property. In particular, the present invention relates to systems and methods for selectively providing stock shares that represent ownership in an entity and at the same time entitle the stockholder to rights to use a property, such as the right to occupy the property.

2. Background and Related Art

A variety of opportunities relating to real estate are available to individuals. One such opportunity relates to vacation accommodations. While the rental of commercial establishments (e.g., hotels and motels) is an available option for vacation accommodations, a variety of frequent travelers have purchased timeshares that offer the right to spend a week or two each year at a popular vacation destination.

Timeshares have proven to be expensive due to the sales efforts typically employed to market and sell the individual timeshares. It has been estimated that up to 50 percent of the purchase price may be ascribed to marketing costs. This built-in burden often results in severe depreciation when the timeshares are resold. (Timeshare User Group, www.TUGZ.net.) Developers typically are responsible for the initial marketing and sales, with management being conveyed to a professional management company upon the sale of the majority of the timeshares. In order to recoup their marketing investment, developers usually require a down payment (e.g., 10%) of the timeshare purchase price. The remaining portion of the purchase price is generally financed through a company subsidiary or a third-party lender. This financing may be at an interest rate that is higher than conventional mortgages because the delinquency rate for timeshare purchases has traditionally been higher and the property securing the loan can be a depreciating asset. The depreciation can occur immediately after a timeshare is purchased, since developers must add to the construction costs the costs of marketing. These marketing costs are not reflected in the value of the property after the initial purchase. Another opportunity relating to real estate is referred to as a real estate investment trust (“REIT”). A REIT is a company dedicated to owning and operating income-producing real estate, such as apartments, shopping centers, offices, and warehouses. Furthermore, REITs are required to pay most (e.g., 90%) of their taxable income to shareholders every year and the shareholders pay taxes at the individual level. Accordingly, a REIT can deduct the dividends paid to the shareholders from its corporate tax bill so long as the company's assets are primarily composed of real estate held for the long term, the company's income is mainly derived from real estate, and the company pays out at least 90 percent of its taxable income to shareholders.

One limitation of a REIT is its restriction on earnings retained by the company. For a REIT to grow, capital must come from money raised in the investment marketplace as well as money generated internally.

### SUMMARY OF THE INVENTION

The present invention relates to providing rights to use a property. In particular, the present invention relates to systems and methods for selectively providing stock shares that entitle the stockholder to rights to use a property, such as the right to occupy the property.

Implementation of the present invention takes place in association with the creation of stock shares that represent ownership in an entity that holds at least one piece of property. The entity may issue use rights as an annual dividend, or the rights can be accrued through another mechanism such as ownership in a property management company or directly through purchase of the stock. In one implementation, a dividend is issued to provide a right to use a property that year, whether real property or personal property. Examples of such properties include a vacation property, a cruise ship, a golf course, commercial real estate, etc. Furthermore, the properties may be new or used. Moreover, the dividend may also include rights to utilize amenities of the property, such as a swimming pool, golf course, exercise facility, pro shop, forms of transportation (e.g., airplanes, automobiles, mass transit, sports vehicle, etc.) and other such amenities may be used or otherwise enjoyed.

In one implementation, a management entity oversees and selectively schedules use of the property according to dividends declared. For example, in one implementation, the use schedule is created by receiving use requests from stockholders and scheduling use of the property according to which stockholder first requested the property for the scheduled date(s). In another implementation, a lottery system is used to assign use dates or periods to the individual stockholders. In yet another implementation, preference to use dates/periods is made based on the number of stock shares owned. Furthermore, in another implementation, a preferred stock is issued to provide a preference in using the property. Moreover, implementation of the present invention embraces the use of fixed, floating, and/or rotating techniques for providing use of the property.

Implementation of the present invention also embraces the exchange of stock shares by individuals. In one implementation, the exchange takes place through a public exchange. In another implementation, the exchange occurs over a computer network, such as the Internet, as will be discussed herein.

While the methods and processes of the present invention are directed initially to the area of vacation real estate, those skilled in the art can appreciate that the methods and processes can be used in a variety of different applications to entitle rights to use of one or more properties, including vacation and commercial, real and/or personal property.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer device for use in managing and/or scheduling use of a property;

FIG. 2 illustrates a representative networked system configuration for use in providing an electronic exchange, in calendaring use of a property, and/or overseeing entitlements to use a property;

FIG. 3 is a flow chart that provides a representative embodiment for allocating stock shares, expenses, and dividends corresponding to use of a property; and

FIG. 4 is a flow chart that provides a representative embodiment for selectively using rights obtained through the purchase of stock.

### DETAILED DESCRIPTION OF THE INVENTION

The present invention relates to providing rights to use a property. In particular, the present invention relates to systems and methods for selectively providing stock shares that entitle rights to use a property, such as the right to occupy the property.

In the disclosure and in the claims the terms “use” or “right to use” shall refer to rights obtained as dividends ancillary to stock purchase or directly through the issuance of stock shares to occupy, enjoy, or otherwise have the benefit of a property, whether real property or personal property, and/or amenities associated with the property. Examples of such properties include, but are not limited to, vacation resorts, cruise ships, golf courses, commercial real estate, etc. Examples of amenities include, but are not limited to, golf courses, ski resorts, beach fronts, water sports, exercise facilities, entertainment facilities, swimming pools, pro shops, automobiles, mass transit, sports vehicles, etc.

As used herein, “floating structure” means a watercraft large enough to serve as a structure. Examples are cruise ships, houseboats, barges, floating lodges, and other floating structures.

As used herein, “entity” means a corporation, company or other form of business organization which may or may not have as its reason for existence the ownership of real or personal property. The current invention anticipates that some entities which have had trouble attracting investors may utilize the invention to attract purchases of stock.

As used herein, the term “user” may refer to the owner of the stock who chooses to occupy or use the property under the terms of the dividend. User may also apply to a third party who gains a right to use the property through an exchange of rights with another property or owner.

Embodiments of the present invention take place in association with the creation of stock shares that represent ownership in an entity and have as an annual dividend a right to use a property. Moreover, embodiments of the present invention embrace the issuance of stock shares to use amenities of the property. In one embodiment, a management entity oversees and selectively schedules use of the property according to ownership of individual stock shares. In a further embodiment, a schedule is created by receiving requests from stockholders and scheduling the use of the property according to which stockholder first requested the property for the scheduled period of time. In another embodiment, a lottery system is used to assign use dates or periods to the individual shareholders. In yet another embodiment, preference to use dates/periods is given based on the number of stock shares owned and/or based on ownership of a preferred stock. The preferred stock may be one class, or several classes having different use rights associated with each class.

Embodiments of the present invention embrace the exchange of use dates/periods. Further, embodiments of the present invention also embrace the exchange of stock shares by individuals. The exchange may be at a public exchange or through an electronic exchange as provided herein

The following disclosure of the present invention is grouped into two subheadings, namely “Managing and Overseeing Use” and “Using Stock Shares to Entitle Use.” The utilization of the subheadings is for convenience of the reader only and is not to be construed as limiting in any sense.

### Managing and Overseeing Use

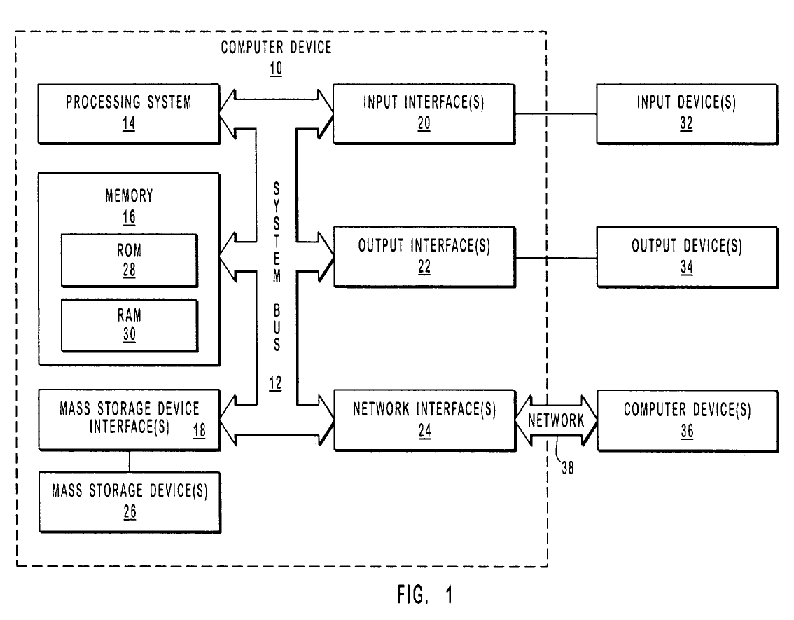

While not required, embodiments of the present embrace the use of one or more computer devices to selectively manage the rights to use one or more properties or otherwise perform methods disclosed herein, wherein the right to use is allocated by stock ownership. Accordingly, FIG. 1 and the corresponding discussion are intended to provide a general description of a suitable computer device for use in accordance with the present invention. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing an embodiment of the present invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

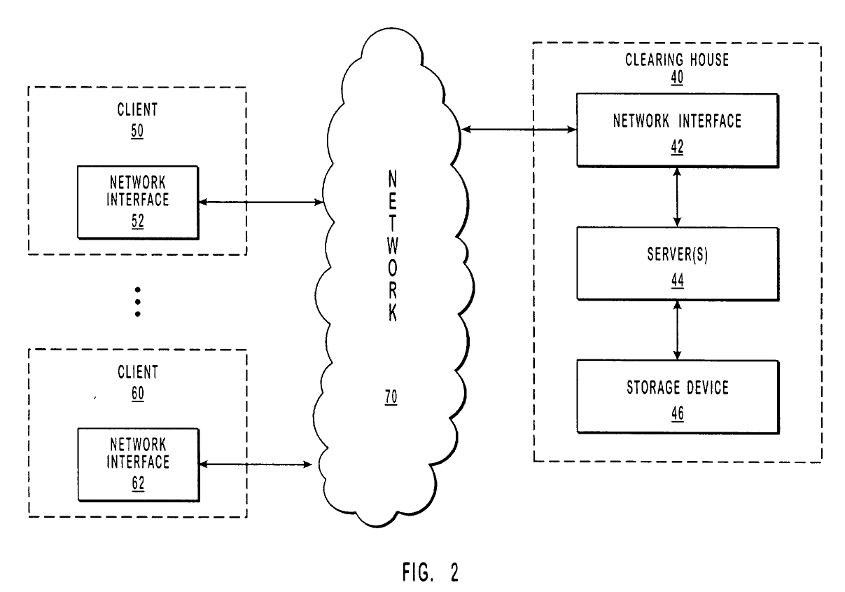

While those skilled in the art will appreciate that the invention may be practiced in networked computing environments with many types of computer system configurations, FIG. 2 represents an embodiment of the present invention that enables electronic exchange of entitlements to use a property, requests for use of a property, scheduling of use, management of stock shares, identification of use, and the like across a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

The emergence of the Internet has enabled a very large number of computer devices across the world to be connected across a wide area network in order to participate in global communication. The following is a discussion of an embodiment of the present invention that includes a plurality of clients, illustrated as clients 50 and 60, that are connected to clearinghouse 40 across the Internet, illustrated as network 70, in order to selectively manage entitlement rights for the use of a property.

In one embodiment, clients 50 and 60 each include a network interface (respectively illustrated as network interfaces 52 and 62) and a Web Browser (not shown). Network interface 52 is a communication mechanism that allows a client, such as client 50 to communicate to clearinghouse 40 by a network 70, such as the Internet. The Web Browsers are application programs that allow information to be displayed on a monitor device as text and/or graphics in the form of a web page. A browser allows for the entering of uniform resource locator (“URL”) to thereby access the corresponding web page. Therefore, clients 50 and 60 may independently access a web page that enables the transmission of property information necessary to selectively manage and/or exchange entitlements to use a property.

Clearinghouse 40 includes network interface 42, application servers 44, and storage device 46. Network interface 42 is a communication mechanism that allows clearinghouse 40 to communicate with one or more clients by network 70. Servers 44 include one or more servers for processing and/or preserving information for the management and/or exchange of rights to use a property. Storage device 46, which may be internal or external to servers 44, includes one or more storage devices for preserving information, such as transactional information, scheduling information and/or stockholder information to perform the methods enclosed herein.

In accordance with embodiments of the present invention, a user at a client may selectively access property information from clearinghouse 40, purchase one or more shares of stock, submit a use request for a particular period of time, locate another shareholder to temporarily swap periods for use of the property, sell shares of stock, and/or receive an use assignment from clearinghouse 40.

In one embodiment, an electronic exchange is provided. Accordingly, and by way of example, a user at client 50 may selectively access a web page corresponding to the electronic exchange. Transactional information is then securely exchanged between client 50 and clearinghouse 40 to enable the purchase or sale of stock at the electronic exchange. Moreover, clearinghouse 40 may be accessed by a user to selectively determine the current price per share of the stock, the type of stock available for purchase, and the number of shares available.

While the discussion above provides a representative system configuration for implementing embodiments of the present invention, those skilled in the art will appreciate that the methods of the present invention and processes thereof may be implemented in a variety of different system configurations. Moreover, while FIG. 2 illustrates the electronic transfer of information relating to an entitlement to use, those skilled in the art will appreciate that other embodiments of the present invention embrace the exchange of information in person, by telephone, mail, facsimile, or electronically, including by electronic mail (“email”).

### Using Stock Shares to Entitle Use

As provided above, the present invention relates to providing entitlement rights to use a property. In particular, the present invention relates to selectively providing stock shares that entitle use.

Embodiments of the present invention embrace the creation of a company or corporation that owns one or more properties for use by individuals. The company gives up a portion of the ownership in the company through the issuing of stock, as will be discussed below. In accordance with embodiments of the present invention, ownership of stock entitles the stockholder with a right to use the property and/or any amenities of the property owned by the company.

In one embodiment, the company, or a management entity, oversees and selectively schedules use of the property according to dividends issued based on stock ownership. In a further embodiment, a schedule to use the property is created by receiving requests from stockholders and scheduling use of the property according to which stockholder first requested the property for the scheduled period of time. In another embodiment, a lottery system is used to assign use dates or periods to the individual shareholders. In yet another embodiment, a preference to use dates/periods is given based on the number of stock shares owned and/or based on ownership of a preferred stock.

Unlike prior art techniques that have proven to be expensive due to the sales expenses required, those sales expenses are greatly reduced when shares of stock in an entity are offered through traditional public offering techniques. Stock brokers forward offering circulars to interested clients and arrange for any subsequent sales or exchanges of stock. The value of the ownership in the entity can fluctuate with the market. Shares purchased immediately after declaration of the dividend will have a lower value. Because the initial price reflects the value of the property and is not inflated to cover marketing expenses, the property may not experience the immediate depreciation experienced with most timeshares. In addition to participation in the traditional equity interests of stock ownership, the present invention anticipates the declaration of an annual dividend that conveys a right to use a property. This right to use can extend for a short period of time in a vacation property such as one week or for a longer period of time in a commercial property. The vacation property may be the sole asset of the entity, or it can be one of several real estate or personal property assets. For example, an entity which traditionally has a long period before profitability such as a pharmaceutical company could purchase a vacation property. Purchasers of stock in the pharmaceutical company would be able to enjoy an annual weekly vacation as a dividend for ownership of the pharmaceutical stock. This benefit to ownership would provide entertainment value to stocks which traditionally do not attract some buyers.

Embodiments of the present invention embrace the use of a board of directors to make decisions for the company. The shareholders in the company meet periodically to determine the board. The board of directors hires the officers of the company (e.g., the president and other major officers), makes company decisions (e.g., the number of stock shares to issue, etc.), and establishes company policies. The board of directors allocates dividends. And, rather than distributing dividends to shareholders, the board of directors of the company may decide to allocate the dividends in other ways, including investing the dividends, purchasing more properties, hiring more employees, and/or otherwise expanding the company.

Embodiments of the present invention embrace either privately held or publicly held companies, wherein in a privately held company the shares of stock are owned by a small number of people that buy and sell their shares amongst themselves, and wherein a publicly held company is owned by thousands of people who trade their shares on a stock exchange.

The stock shares of a publicly traded company are bought and sold at a stock market or stock exchange. Examples of such markets include the New York Stock Exchange (“NYSE”), the American Stock Exchange (“AMEX”), and the National Association of Securities Dealers (“NASDAQ”). The publicly traded company lists its stock on an exchange to enable the buying and/or selling of shares. Furthermore, as provided herein, embodiments of the present invention embrace electronic stock exchanges that are available across a networked computer system to enable buying and/or selling of stock that entitles use of a property. The stock exchange enables an orderly market for buyers and sellers of its listed shares, and allows the price of a stock to be known throughout the business day. Accordingly, investors watch fluctuations in a stock's price.

Buy or sell orders at a public exchange are typically executed by stockbrokers who are members of the particular exchange. The stockbroker buys and/or sells stock on behalf of the investor. In one embodiment, when an investor contacts a broker, the broker relays the investor's trade to the floor of the appropriate exchange, and a representative of the company or a computer representing the company makes the trade on behalf of the investor. A commission may be paid to the broker for the service.

In accordance with embodiments of the present invention, individual stockholders are able to use the exchange, whether public or electronic, or are able to use a stockbroker in their behalf.

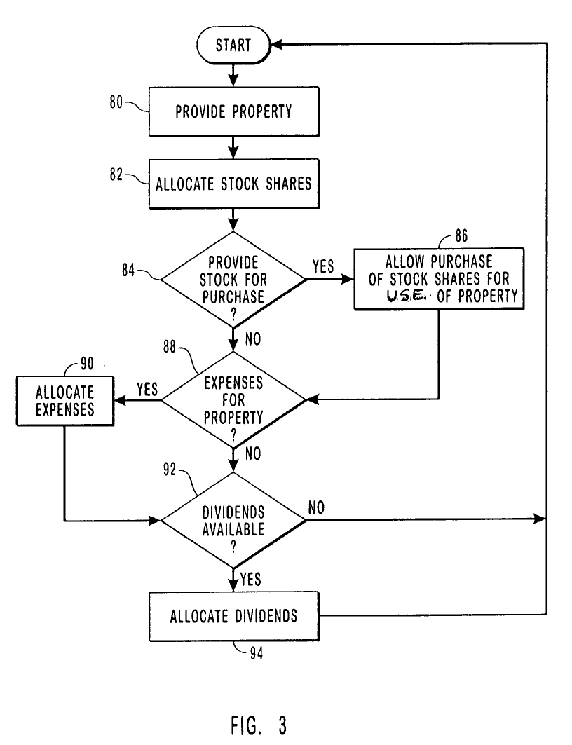

With reference now to FIG. 3, a flow chart is provided that illustrates a representative embodiment for allocating stock shares, expenses, and dividends relating to entitlements for use. In FIG. 3, execution begins at step 80 where a property is provided. The property is owned by the company and may be a single property or a variety of properties. Furthermore, the property may be real estate (e.g., a vacation property) or personal property (e.g., a cruise ship, houseboat, etc.) At step 82, stock shares are allocated for the property. As provided above, the stock shares entitle use of the property that was provided in step 80.

Execution then proceeds to decision block 84 for a determination as to whether or not to provide stock for purchase. If it is determined at decision block 84 that stock is to be provided for purchase, execution proceeds to step 86 where the stock shares are made available for purchase. As provided above, this may be at a public or electronic stock exchange or by word of mouth. Upon purchase of the stock, the stockholder is entitled to use the property for a period of time. Alternatively, if it is determined at block 84 that stock shares are not available for purchase, execution proceeds directly to decision block 88.

At decision block 88, a determination is made as to whether or not there exist expenses for the property. If it is determined at decision block 88 that expenses exist for the property, execution proceeds to step 90, where the expenses are allocated according to stock ownership, and then to decision block 92. Alternatively, if it is determined at decision block 88 that no expenses exist for the property, execution proceeds directly to decision block 92.

At decision block 92, a determination is made as to whether or not dividends are available for allocation. In one embodiment, a dividend is the right to use. In another embodiment, dividends are available where, for example, particular shares are not made available for purchase in order to allow for renting the property during the corresponding periods of time that are represented by the un-purchased stock shares. If it is determined at decision block 92 that no dividends are available for allocation, execution returns back to start. Alternatively, if it is determined at decision block 92 that dividends are available, execution proceeds to step 94 where the dividends are allocated according to stock share and then execution returns back to start.

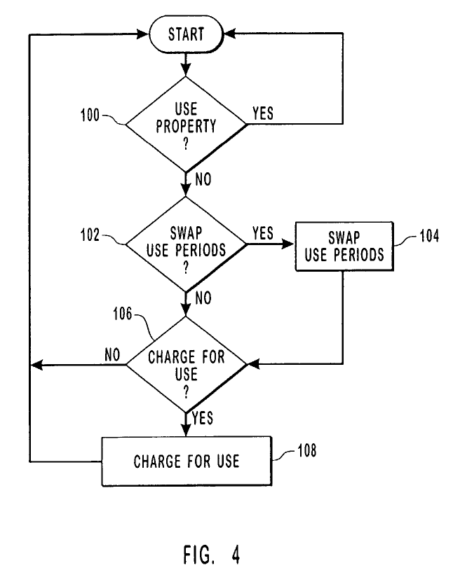

With reference now to FIG. 4, a flow chart is provided that illustrates a representative embodiment for selectively using rights obtained through the ownership of stock. For example, in FIG. 4 execution begins at decision block 100 for a determination as to whether or not the stockholder will use the property during a period of time for which the stockholder is scheduled for use of the property. If it is determined at decision block 100 that the stockholder will use the property, execution returns back to start.

Alternatively, if it is determined at decision block 100 that the stockholder will not use the property during the scheduled period of time, execution proceeds to decision block 102 for a determination as to whether or not the stockholder desires to swap use periods with another shareholder. The swapping of use periods is a temporary swap as opposed to an exchange or purchase of shares. Moreover, the swapping of use periods is an exchange between stockholders of time periods for which the stockholders are entitled to use the property.

Accordingly, if is it determined at decision block 102 that use periods corresponding to the shares are to be swapped, execution proceeds to step 104, where the use periods corresponding to the shares are swapped to entitle an exchange in the periods of time in which the use can occur for the stockholder. Execution then proceeds to decision block 106. Alternatively, if it is determined at decision block 102 that the stockholder does not desire to swap use periods corresponding to the shares or time periods, execution proceeds directly to decision block 106. This swapping of use periods is controlled in one embodiment by a professional property management company and is not directly managed by the entity. Some embodiments may incorporate management into the responsibilities of the board of the entity. In embodiments where a professional management company controls the actual date of use of the right conveyed by the declaration of dividends, then annual fees will be charged by the management company directly to the users. As a result, the value of the vacation property may vacillate independently from the value of the entity. Although the value of the vacation property will be indirectly reflected in the price of the stock of the entity, it may represent only a small portion of the value represented by the share price. For example, although the dividend may appeal to some purchasers, it may represent only a small portion of the price of a share of a large pharmaceutical company. An entity may wish to divorce itself from the potential variations in value of the vacation property by being responsible for a fixed contribution only and having the management company charge the user for any variations in user fees for maintenance, improvements, etc. In this embodiment, the dividend would take the form of a right to a weekly reservation at the vacation property for up to a fixed value. Any management fees above that value would be charged to the user. In situations where the vacation property represents a large portion of the assets of the entity, the entity may simply wish to absorb increases and issue a dividend that incorporates the increases without additional cost to the user, or the entity may wish to keep the dividend constant and have the management company allocate increases directly to users.

At decision block 106, a determination is made as to whether or not to charge for use of the property during the time in which the stockholder is entitled to use the property, but will not be using the property. The illustrated embodiment embraces a stockholder renting out the property for use of the property during the time in which the stockholder is entitled to personally use the property. Accordingly, if it is determined at decision block 106 that the shareholder is not going to charge for use, then execution returns back to start. However, if it determined at decision block 106 that the shareholder will charge for use (e.g., rent out the property for the time period in which the stockholder is entitled to use the property), execution proceeds to step 108 where the charge is made for the use. Execution then returns back to start.

As provided above, embodiments of the present invention also embrace the right to use a property as the dividend. In embodiments where a management company is employed to allocate costs of maintenance and improvements, an individual may choose not to participate in those costs and opt out of the dividend. This decision may be made due to personal financial situations or health issues. These stockholders will still benefit from ownership in the entity, but will not have any ongoing additional expenses from the management company. In a further embodiment, an option to not receive the dividend is for a period of time, and upon opting to not receive the dividend the managing company would attempt to rent out any extra rooms. If the management company could not successfully maintain the property at an acceptable occupancy level, the management company would notify the entity and the board of directors could issue more shares of stock. These additional shares would have dividends that would provide stockholders the opportunity to fill the vacation property while simultaneously increasing the value of the outstanding shares Accordingly, a vehicle is provided to generate a cash infusion to the company.

Thus, as discussed herein, the embodiments of the present invention relate to providing entitlement to use a property. In particular, the present invention relates to systems and methods for selectively providing stock shares that entitle use of real estate. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method of providing equity ownership in an entity which has as an asset real estate, the method comprising issuing publicly traded stock shares in an entity which owns real estate; and
declaring an annual dividend entitling the stockholder with a right to use the real estate for a fixed period.

2. A method as recited in claim 1, wherein the step for issuing stock shares comprises at least one of the steps for:
(i) providing the stock shares at a public stock exchange;
(ii) providing the stock shares at an electronic exchange; and
(iii) privately providing the stock shares.

3. A method as recited in claim 1, wherein the stock shares include shares of a preferred stock.

4. A method as recited in claim 1, wherein the stock shares are issued in a plurality of classes and values

5. A method as recited in claim 1, further comprising the step for selectively scheduling a use period to a stockholder.

6. A method as recited in claim 5, wherein the step for selectively scheduling a use period comprises one of the steps for:
(i) receiving a use request from the stockholder;
(ii) using a lottery system to schedule the use period; and
(iii) providing a preference in scheduling the use period based on at least one of:
(a) a number of the stock shares owned by the stockholder; and
(b) a type of the stock shares owned by the stockholder.

7. A method as recited in claim 6, wherein the type of the stock shares is a preferred stock.

8. A method as recited in claim 6, wherein the step for receiving a use request comprises the step for resolving any conflict caused by the occupancy request.

9. A method as recited in claim 1, further comprising at least one of the steps for:
(i) allocating expenses; and
(ii) allocating dividends.

10. A method for using a property comprising:
purchasing stock that entitles use of a property;
selectively obtaining a use period to exercise the use entitlement; and
using the property during the use period.

11. A method as recited in claim 10, wherein the step for purchasing stock comprises one of the steps for:
(i) using a public stock exchange;
(ii) using an electronic exchange; and
(iii) privately purchasing the stock.

12. A method as recited in claim 10, wherein the step for selectively obtaining a use period comprises at least one of the steps for:
(i) providing a use request;
(ii) receiving the use period from a lottery system that assigns use periods; and
(iii) using a scheduling preference to obtain the use period.

13. A method as recited in claim 10, wherein the step for using the property during the use period comprises at least one of the steps for:
(i) swapping the use period for another use period; and
(ii) charging another individual to use the property during the use period.

14. A computer program product for implementing within a computer system a method for selectively managing use of a property, the computer program product comprising:
a computer readable medium for providing computer program code means utilized to implement the method, wherein the computer program code means is comprised of executable code for implementing the steps for:
providing stock ownership information, wherein ownership of a share of the stock entitles use of a property; and
using the stock ownership information to determine use of the property for a particular use period.

15. A computer program product as recited in claim 14, wherein the step for providing stock ownership information comprises the step for electronically offering the stock for sale.

16. A computer program product as recited in claim 15, wherein the step for providing stock ownership information further comprises the step for electronically performing a purchase transaction for the stock.

17. A computer program product as recited in claim 14, wherein the step for using the stock ownership information to determine use of the property for a particular use period comprises one of the steps for:
(i) receiving a use request from a stockholder;
(ii) using a lottery system to schedule the use period; and
(iii) providing a preference in scheduling the use period.

18. A computer program product as recited in claim 17, wherein the step for providing a preference is based on at least one of:
(i) a number of stock shares owned by the stockholder; and
(ii) a type of stock share owned by the stockholder.

19. A computer program product as recited in claim 17 wherein the step for receiving a use request comprises the step for resolving a conflict caused by the use request

20. A method for distributing rights to use a property, comprising:
(i) issuing shares of stock to convey an equity interest in an entity;
(ii) declaring as an annual dividend a right to use a property; and
(iii) contracting with a management company to arrange for scheduling of the use of the property and to maintain the property and to charge owners of the shares of stock a management fee.

21. A method as recited in claim 20, wherein the owners of the shares of stock may opt out of the payment of management fees by declining the dividend for a fixed number of years.

22. A method as recited in claim 21, wherein the entity may sell additional shares of stock upon declination of enough dividends to allow use of the property by additional owners without over subscription.

23. A method as recited in claim 1, wherein the entity uses the dividend to entice purchase of stock by individuals who would not otherwise consider ownership in that type of entity.

24. A method as recited in claim 20, wherein the property is a floating structure.

25. A method as recited in claim 20, wherein the property is an aircraft.
